(19) United States
(12) Patent Application Publication
(10) Pub. No.: US 2025/0024864 A1
(43) Pub. Date: Jan. 23, 2025

(54) METHOD FOR PRODUCING A SEAFOOD IMITATION PRODUCT

(71) Applicant: FUKUICHI FISHERY CO., LTD, Yaizu-Shi (JP)

(72) Inventors: Taichiro Kondo, Yaizu-Shi (JP); Daisuke Kondo, Yaizu-Shi (JP); Hiroshi Kondo, Yaizu-Shi (JP); Akito Kobayashi, Yaizu-Shi (JP)

(21) Appl. No.: 18/777,172

(22) Filed: Jul. 18, 2024

(30) Foreign Application Priority Data
Jul. 18, 2023 (JP) 2023-116426

(51) Int. Cl. A23L 5/44; A23L 3/36; A23L 23/00; A23L 33/21

(52) U.S. Cl. CPC A23L 5/44; A23L 3/36; A23L 23/00; A23L 33/21

(57) ABSTRACT

The object of the present invention is to provide a method for producing the reproducible seafood imitating product which can reproduce the flesh of the seafood better than before.

A method for producing the seafood imitating product of the present invention is provided. The present invention is a method for producing the seafood imitating product including dietary fiber which comprises heat mixing dietary fiber, tapioca powder, thickener and water to obtain a flesh solution, solidifying the flesh solution to obtain a solidified body and freezing the solidified body.

### CROSS-REFERENCE TO RELATED APPLICATION

This application claims priority to Japanese Patent Application No. 2023-116426, filed on Jul. 18, 2023, which is hereby incorporated by reference in its entirety.

### TECHNICAL FIELD

The present invention relates to a method for producing a seafood imitating product.

### BACKGROUND ART

There are various principles and ideas also in the meal in the present days when the human diversity has been called for loudly. For example, vegetarians who do not take meat, and the like exist, although they are generally called vegetarians, not only vegetarians who take egg or milk, and the like, but also total vegetarians (so-called Vegans) who abstain from all food of animal origin exist.

Even if they are Vegans, they sometimes want to take the food except vegetables, and the like. In order to satisfy such a desire, for example, as described in patent document 1, the imitation food which imitates the food derived from animals but does not use materials derived from animals is developed.

### CITATION LIST

### Patent Literature

### [PTL 1]

Japanese unexamined patent publication No. 2021-159076

### SUMMARY OF INVENTION

### Technical Problem

A lot of imitation food is developed. However, the seafood imitating product imitating seafood, and the like cannot reproduce the flesh of seafood enough so far. Therefore the conventional seafood imitating product did not satisfy the appetite of a person who eats them.

The present invention is intended to provide a method for producing a seafood imitating product which can reproduce the flesh of seafood reproducibly than before.

### Solution to Problem

The inventor(s) of the present invention found that the seafood imitating product which the special cloudiness of seafood flesh was reproduced could be produced when solidifying the flesh solution obtained by mixing dietary fiber and tapioca powder, and freezing this solidified body, and the present invention was completed.

Also, the inventor(s) of the present invention found that the seafood imitating product reproduced the special color of seafood, particularly tuna, could be produced by solidifying the flesh solution obtained by mixing dietary fiber and lycopene pigment in water, and obtaining the solidified body, and the present invention was completed.

Therefore, the present invention provides a method for producing a seafood imitating product including dietary fiber, comprising:
mixing dietary fiber, tapioca powder, thickener and water to obtain a flesh solution
solidifying the flesh solution to obtain a solidified body, and
freezing the solidified body.

Also, the present invention provides the method for producing the seafood imitating product described above wherein the flesh solution is prepared by further mixing with a colorant different from the tapioca powder.

Also, the present invention provides the method for producing the seafood imitating product described above wherein the colorant is lycopene pigment; and the method further comprises heating the flesh solution before solidifying the flesh solution.

Also, the present invention provides the method for producing the seafood imitating product wherein the freezing of the solidified body is performed at 0° C. or less.

Also, the present invention provides the method for producing the seafood imitating product wherein the flesh solution is prepared by further mixing with vegetable ingredients.

Alternatively, the present invention provides a method for producing a seafood imitating product including dietary fiber, comprising:
mixing dietary fiber and lycopene pigment in water to obtain a flesh solution;
heating the flesh solution; and
solidifying the flesh solution to obtain a solidified body.

### Advantageous Effects of Invention

The special cloudiness of seafood flesh which cannot be developed when not adding tapioca powder can be reproduced when solidifying the flesh solution obtained by mixing dietary fiber and tapioca powder, and freezing this solidified body. Besides, the mouthfeel of seafood can be also reproduced. Furthermore, the red flesh such as tuna or salmon, can be reproduced when mixing colorant different from tapioca, for example, lycopene pigment and paprika pigment. The flesh solution may contain various ingredients, and ingredients increasing flavors can be added.

Also, the seafood imitating product which the special red color of tuna is reproduced can be produced, by mixing dietary fiber and lycopene pigment in water to obtain a flesh solution, and heating and then solidifying this flesh solution to obtain a solidified body.

### BRIEF DESCRIPTION OF DRAWINGS

FIG. 1 is a flow diagram of an example of the method for producing the seafood imitating product concerning the first embodiment.

FIG. 2 is a flow diagram of other example of the method for producing the seafood imitating product concerning the first embodiment.

FIG. 3 is a schematic diagram indicating a step of making the layer of the flesh solution in an example of the method for producing the seafood imitating product concerning the first embodiment. “1” refers to solidified body, “2” refers to seafood imitating product.

FIG. 4 is a schematic cross-sectional view of the solidified body and the seafood imitating product which can be obtained in an example of the method for producing the seafood imitating product concerning the first embodiment. “3” refers to layer of the flesh solution.

FIG. 5 is a flow diagram of an example of the method for producing the seafood imitating product concerning the second embodiment.

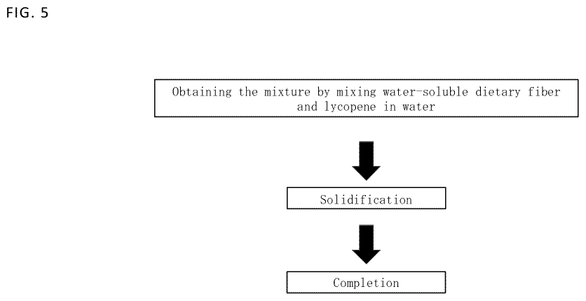

### DESCRIPTION OF EMBODIMENTS

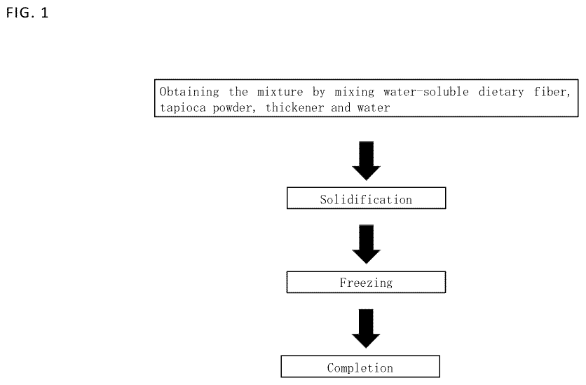

Some examples of the method for producing the seafood imitating product concerning the embodiment are described below, referring to the drawings. However, the method for producing the seafood imitating product of the present invention is not limited to the examples described below.

[first embodiment] Referring to FIG. 1-FIG. 3, an example of the method for producing the seafood imitating product concerning the first embodiment of the present invention is described.

### <Preparation of the Flesh Solution>

At first, dietary fiber, tapioca powder, thickener and water are mixed and a mixture is obtained. As used herein, the solution obtained by mixing at least dietary fiber, tapioca powder, thickener and water is referred to as flesh solution. The flesh solution is the material that forms the part imitating fish flash. The word “fish flash” also referred to fish meat.

The container to mix is not particularly limited. For example, mixing and subsequent heating can be performed in the same container by using a pot such as a heat-adjustable electric pot.

For example, dietary fiber can be water-soluble dietary fiber. Herein, the water-soluble dietary fiber is dietary fiber dissolving in a water solution, and includes dietary fiber having a property to increase the viscosity of the water solution by dissolving in the water solution. The water-soluble dietary fiber as used herein can be, but is not particularly limited to, for example, glucomannan (e.g., konjac potato), dietary fiber derived from seaweed (e.g., agar) and chemically modified polysaccharide (e.g., modified starch), and the like. Glucomannan is polysaccharide existing in a konjac potato. Glucomannan can be obtained as konjac powder, for example, by drying and crushing a konjac potato and separating impurities. Konjac powder includes about 75-85% by mass of glucomannan. A commercial product can be used for Glucomannan.

The quantity of dietary fiber can be adjusted so that desired hardness and viscosity are obtained in the seafood imitating product, and can be, for example, per 100 parts by mass of the flesh solution, 0.3 parts by mass or more to 10 parts by mass or less of the quantity, and it is preferable to be 0.5 parts by mass or more to 7 parts by mass or less of the quantity.

The tapioca powder is powder of starch produced from the roots of cassava. The tapioca powder can not only reproduce whiteness of seafood by being contained in the seafood imitating product, but can also reproduce the color of the flesh of seafood by being used together with other colorant(s). The seafood imitating product containing the tapioca powder of the present invention can produce white color by freezing after solidification.

The quantity of the tapioca powder can be adjusted so that desired whiteness, hardness and viscosity are obtained in the seafood imitating product of the present invention, and can be, for example, per 100 parts by mass of the flesh solution, 1 part by mass or more to 10 parts by mass or less of the quantity, and it is preferable to be 2 parts by mass or more to 8 parts by mass or less of the quantity. Also, the tapioca powder may be provided as a solution by mixing the powder in the solvent such as water and the tapioca powder may also be provided as a solution by heating and dissolving it in a solvent.

The thickener used for the seafood imitating product of the present invention is not limited, as long as it is a thickener for food. The thickener can be, for example, methylcellulose, locust bean gum, guar gum, gellan gum, carboxymethyl cellulose, arabic gum, xanthan gum, cornstarch, carrageenan and pectin. The quantity of the thickener can be adjusted so that desired hardness and viscosity are obtained in the seafood imitating product of the present invention, and can be, for example, per 100 parts by mass of the flesh solution, 0.3 parts by mass or more to 5 parts by mass or less of the quantity, and it is preferable to be 0.5 parts by mass or more to 3 parts by mass or less of the quantity.

When preparing the flesh solution, each ingredient can be mixed at any temperature. However, materials is not dissolved sufficiently and lumps occur only by mixing materials in water. The temperature to mix can be set at 1° C. or more to 30° C. or less to prevent the lump of materials from occurring. Alternatively, the mixture may be produced to prevent the lump of materials from occurring while stirring raw materials in water by a high-speed stirrer. Also, when preparing the flesh solution, it is preferable to heat after mixing. It is preferable to perform heating to become the temperature that ingredients of the mixed flesh solution dissolve, for example, at 85° C. or more to 100° C. or less. The color of seafood wanted to imitate can be reproduced closer by performing heating of the flesh solution. Heat mixing is preferable. The temperature of heat mixing is preferably at 60° C. or more, more preferably at 75° C. or more to 100° C. or less.

The flesh solution after heating has viscosity with fluidity. The viscosity of the flesh solution changes depending on the temperature. The higher the temperature is, the lower viscosity the flesh solution has, because each ingredient dissolves by heating. When the solution temperature is at, for example, 60° C.-100° C., the viscosity of the flesh solution can be 10 dPa·s-500 dPa·s, for example, 50 dPa·s-200 dPa·s, for example, 60 dPa·s or more to 150 dPa·s. Also, the viscosity of the flesh solution can be 10 dPa·s-500 dPa·s, for example, 50 dPa·s-200 dPa·s, for example, 60 dPa·s-150 dPa·s when the solution temperature is, for example, 70° C.-85° C.

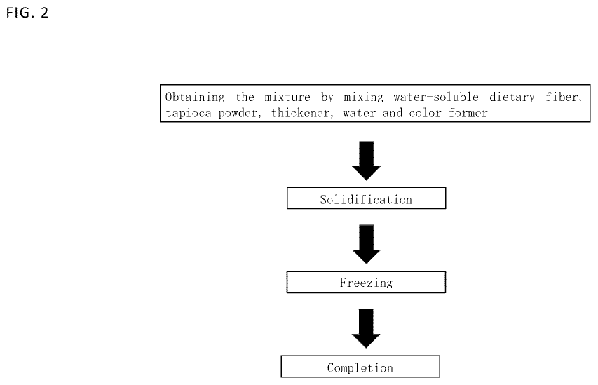

In this case, as shown in FIG. 2, the colorant different from tapioca can be added. Another colorant can be a colorant developing a desired color, and includes, for example, lycopene pigment and paprika pigment, but is not limited.

When lycopene pigment is added to the flesh solution, the feel of the red flesh of tuna can be finally reproduced. The feel of the red flesh of tuna can be finally reproduced. Lycopene pigment can be added with, per 100 parts by mass of the flesh solution, 0.01 parts by mass or more to 3.0 parts by mass or less, for example, 0.05 parts by mass or more to 0.5 parts by mass or less of the quantity. By containing lycopene pigment with such a quantity, the color of the red flesh and texture of tuna can be reproduced by the effect of white due to the tapioca powder and red due to lycopene pigment.

For example, lycopene pigment can be tomato pigment. Lycopene pigment may be added as a mixture with other ingredients. For example, lycopene pigment can be added as a mixture of glycerin, food materials (e.g., water), sucrose fatty acid ester, lecithin and tomato pigment as lycopene pigment.

When lycopene pigment and paprika pigment are added, the feel of the flesh of salmon trout can be reproduced in the seafood imitating product. Paprika pigment can be used with the quantity to reproduce a desired flesh color, and can be added, for example, per 100 parts by mass of the flesh solution, 0.01 parts by mass or more to 3.0 parts by mass or less, for example, 0.05 parts by mass or more to 0.5 parts by mass or less of the quantity. By containing lycopene pigment and paprika pigment with such a quantity, the color and texture of the flesh of salmon trout can be reproduced by the effect of white due to the tapioca powder, red due to lycopene pigment and orange of paprika pigment. Furthermore, the feel of the flesh of salmon trout in the seafood imitating product can be reproduced more when titanium dioxide is added to the mixture.

For example, paprika pigment may be red pepper pigment. Paprika pigment may be added as a mixture with other ingredients. For example, paprika pigment can be added as a mixture of food materials (e.g., water), mixed tocopherols and red pepper pigment as paprika pigment.

When adding the colorant(s) different from the tapioca powder, the color does not become as expected when the colorant(s) is mixed after heating. Therefore, when adding the colorant(s) different from the tapioca powder, it is preferable to heat the flesh solution obtained by mixing other materials and colorant(s) together. When heating, it is preferable to heat so that the temperature of the flesh solution is at between 85° C.-100° C. The colorant(s) such as tapioca powder, lycopene pigment and paprika pigment, by heating in the flesh solution, can make coloring better and can reproduce the color of the seafood wanted to imitate more.

The colorant(s) different from the tapioca powder may not be added. When not adding another colorant(s), the white feel of the flesh of squid can be reproduced after freezing and defrosting by an effect of the tapioca powder.

The flesh solution may be heated to above the melting point of each raw material of dietary fiber, tapioca powder, thickener and colorant(s). When the flesh solution is not heated to above the melting point of each raw material, syneresis occurs when freezing and defrosting the seafood imitating product in the subsequent steps. Therefore, the method for producing the seafood imitating product of the present invention may further comprise heating the flesh solution after preparing the flesh solution.

The flesh solution can further include any additives to give the seafood imitating product an objective flavor. Particularly, the taste of the seafood imitating product can be made better by the taste of the vegetable soup by adding vegetable ingredients while imitating the seafood for the mouthfeel. Surprisingly, the inventor(s) of the present invention found that a flavor of the seafood imitating product could be improved by adding vegetable ingredients different from the fish.

Vegetable ingredients may be liquid state and may be granular. In case of liquid state, that is, vegetable soup, it may be the soup derived from animals such as the bouillon, and may be the soup which does not include those derived from animals for Vegans.

The vegetable soup can include, but is not particularly limited to, for example, water, soy sauce, sugar, salt, fermented seasoning, vegetables (onion, celery, carrot, and the like) and yeast extract as ingredients.

The flesh solution can include other ingredients. The flesh solution also can include, for example, hydroxypropyl starch to increase preservation stability. The flesh solution also can include, for example, potassium chloride as an anticaking ingredient. The anticaking agent is necessary when keeping powder formulation, and is mixed to raw materials. The anticaking agent may be included in raw materials to produce the seafood imitating product of the present invention, and therefore the anticaking agent may be included in the seafood imitating product. Also, glucose and dextrin, and the like can be added to the flesh solution to give the seafood imitating product a feeling of chewy and firmness. Also, the flesh solution can include further ingredients to reproduce a desired color.

### [Formation of a Layer of the Flesh Solution]

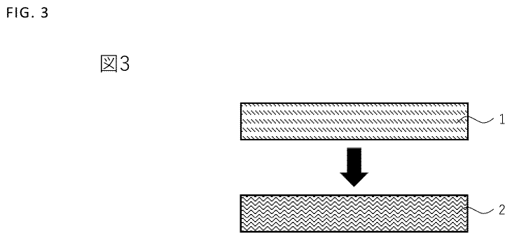

Next, a layer of the flesh solution is formed. The layer of the flesh solution can be formed by any means and can be formed only by, for example, pouring the flesh solution into a container. For example, as shown in FIG. 3, layer of the flesh solution 3 can be formed by pouring the flesh solution into mold 100. As for the flesh solution, the viscosity changes depending on the temperature after heating as described above. Therefore, the layer of the flesh solution can be formed easily if it has the viscosity that the flesh solution can be poured into the container. Also, the layer of the flesh solution may be formed by heating the flesh solution solidified once in the container again.

### <Solidification>

Next, the flesh solution are solidified. Herein, to solidify includes to solidify the liquid flesh solution to the condition where it is not liquid and does not have fluidity, and, for example, includes to form a solidified gelatinous gel.

The solidified body can be obtained by solidifying the flesh solution by the method that depends on ingredients of the flesh solution, for example, by increasing viscosity and removing fluidity of the flesh solution.

The flesh solution can be solidified, for example, by cooling. The flesh solution can be solidified, for example, by cooling the flesh solution at 20° C. or less using the rapid coolers such as blast chillers by the air blast. Also, the flesh solution can be solidified by cooling to 0° C.-4° C. rapidly. However, it is preferable to rapidly cool and solidify to raise safety, quality and efficiency at the time of cooling. Alternatively, as for the flesh solution, when using, for example, glucomannan as dietary fiber, edible calcium hydroxide called the lye is added to the flesh solution, and solidification (coagulation) of the flesh solution can be performed by mixing. After solidifying the flesh solution, the solidified flesh solution may be molded into any shape.

### <Freezing>

Next, the solidified flesh solution is frozen. The temperature of freezing can be performed at, but is not particularly limited to, for example, 0° C. or less, and the temperature of −18° C. or less, for example, can be cooled at −20° C.-−40° C. As for the means of freezing, it is preferable to, but is not particularly limited to, quick freeze. The freezing can be quick freezing, for example, by a blast chiller by the air blast or a brine. Also, the steps of cooling and freezing may be carried out by cooling in succession, and it may be frozen at 0° C. or less directly.

The inventors of the present invention found that the cloudiness just like the seafood could be given to the solidified body by freezing the solidified body obtained by solidifying the flesh solution described above including tapioca. Also, it becomes easy to cut the imitation food by freezing. If the cloudiness, which the seafood imitating product of the present invention has, is not provided to the solidified body, transparency of the imitation food becomes higher too much, and it becomes to the gelatinous feel food which cannot be seen as the seafood.

After freezing, defrosting may be performed to produce the seafood imitating product. Alternatively, a frozen state may be assumed a finished product without defrosting.

A schematic cross-sectional view of the solidified body and the seafood imitating product which can be obtained in an example of the method for producing the seafood imitating product concerning the first embodiment is shown in FIG. 3.

Solidified body 1 before freezing has feel with a little cloudiness or no cloudiness. Therefore, the cloudiness of the flesh peculiar to the seafood cannot be reproduced enough. On the other hand, seafood imitating product 2 after freezing presents just like the cloudiness peculiar to the seafood.

That is, according to the seafood imitating product of the present invention, the cloudiness of the flesh peculiar to the seafood can be reproduced. Besides, the mouthfeel of the seafood can also be reproduced. Furthermore, the red fleshs such as tuna or salmon can be reproduced when mixing the colorant different from tapioca, for example, lycopene pigment and paprika pigment, and using the heated flesh solution. The flesh solution may be added with various ingredients, and ingredients which increase flavors can be added.

### Second Embodiment

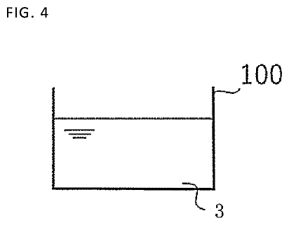

Next, referring to FIG. 4, an example of the method for producing the seafood imitating product concerning the second embodiment of the present invention is described.

### <Preparation of the Flesh Solution>

At first, dietary fiber and lycopene pigment is mixed in water to obtain the flesh solution.

As dietary fiber, for example, those which was presented in the first embodiment can be used.

It is preferable to set the temperature to mix at 1° C.-30° C., or to use a high-speed stirrer to prevent the lump in the materials from occurring at the time of mixing.

It is preferable for heating to be performed so that the temperature of the flesh solution becomes at between 85° C.-100° C. By performing heating of the flesh solution, the color of the seafood wanted to imitate can be reproduced closer.

Per dietary fiber 100 parts by mass, lycopene pigment can be added with, per 100 parts by mass of the flesh solution, 0.01 parts by mass or more to 3.0 parts by mass or less, for example, 0.05 parts by mass or more to 0.5 parts by mass or less of the quantity.

The flesh solution can further include any additives to give the seafood imitating product of the object an objective flavor as the first embodiment. Particularly, the seafood imitating product giving a taste of vegetables can be produced by adding vegetable ingredients while imitating the mouthfeel of the seafood.

Also, the flesh solution can include other ingredients as the first embodiment. For other ingredients, those presented in the first embodiment can be used.

### <Solidification>

The solidification can be performed depending on a kind of dietary fiber at the appropriate time as described in the first embodiment.

According to the method for producing the seafood imitating product concerning such second embodiment, the seafood imitating product which the color of the red flesh peculiar to tuna is reproduced can be produced.

### Example 1

The squid imitating product was produced.

### [Preparation of the Flesh Solution]

At first, the raw materials of ingredients shown in Table 1 was prepared to produce the squid imitating product. In Table 1, the composition amount is shown in kg, and the composition ratio in the final flesh solution is shown as % by weight.

TABLE 1

| | composition amount | composition ratio |
|---|---|---|
| | (kg) | (% by weight) |
| raw materials 1 | | |
| clean water | 66 | 76.48% |
| dextrin | 4 | 4.63% |
| mannan | 0.711 | 0.82% |
| carrageenan | 0.594 | 0.69% |
| locust bean gum | 0.24 | 0.28% |
| guar gum | 0.156 | 0.18% |
| gellan gum | 0.036 | 0.04% |
| xanthan gum | 0.012 | 0.01% |
| potassium chloride | 0.201 | 0.23% |
| glucose | 0.987 | 1.14% |
| agar | 0.063 | 0.07% |
| salt | 0.15 | 0.17% |
| raw materials 2 | | |
| clean water | 4 | 4.63% |
| tapioca starch | 4 | 4.63% |
| raw materials 3 | | |
| vegetable soup | 5 | 5.79% |
| total | 86.15 | 99.83% |

Ingredients shown in raw materials 1 were added into the pot of, outside size: 1,850 mm in width, 1,090 mm in depth, 1,160 mm in height, inside diameter of inner pot: 1,000 mm, depth of inner pot: 560 mm, quantity of full water: approximately 380 liters and mixed with a stirrer. The temperature was controlled at 30° C. or less.

On the other hand, the solution of tapioca starch shown in raw materials 2 was prepared. 4 kg of tapioca starch (4.63% by weight in the final flesh solution) was put into 4 kg of water (4.63% by weight in the final flesh solution), and mixed. The mixing was performed at 30° C. or less. The prepared cornstarch and tapioca solution of raw materials 2 were put into the mixture of raw materials 1 described above.

The vegetable soup of raw materials 3 has composition showing in Table 2, which is shown as % by weight.

TABLE 2

| | |
|---|---|
| water | 43.71% |
| soy sauce | 12.24% |
| sugar | 11.02% |
| salt | 10.04% |
| onion | 8.74% |
| fermentated seasoning | 4.90% |
| celery | 4.37% |
| carrot | 4.37% |
| yeast extract | 0.61% |

Next, heating of the contents of the pot was started. During heating, 5 kg of vegetable soup (5.79% by weight of the final flesh solution) was put into the pot containing raw materials 1 and raw materials 2.

Heating was stopped at the point when the contents of the pot exceeded 85° C. Thereby, the flesh solution was obtained.

The viscosity of the flesh solution of this time was measured. The viscosity was measured according to the procedure using VISCOMETER VT-06, RION CO., LTD. The viscosity was 70 dPa·s-80 dPa·s when the temperature of the flesh solution was at 80° C.-85° C.

Also, Brix level of the flesh solution was measured at the point when the temperature of the center core was at 85° C. by a Brix scale as the viscosity of the solution. The density of the flesh solution was 15%-18%. Note that, herein, “Brix level” is the physical quantity used as a sugar content to measure content of the sugar. When measuring 100 g of water solution including only 1 g of sucrose as a solute by Brix refractometer, the Brix level which is its indication is 1%. For example, as for the solution which 10 g of sucrose dissolved in 100 g of solution (90 g of water), a Brix level becomes 10%. For example, the flesh solution can be 1%-40%, 12%-20% or 15%-18% of Brix levels.

### [Formation of the Layer of the Flesh Solution]

The flesh solution at 80° C.-85° C. was put in a mold, and the layer of the flesh solution was formed.

### [Solidification]

In this state, the flesh solution was solidified, respectively. The flesh solution was solidified by cooling the container at 0° C.-4° C. with a blast chiller to obtain a solidified body.

### [Freezing]

The solidified body was rapidly cooled in a freezer at −40° C., and the solidified body of the flesh solution was frozen.

### [Defrosting]

A frozen solidified body was bagged, and the bag was sealed. The bag was put in warm water at 50° C. or less, and was left for 0.5 hours. Thereby, defrosting was performed, and the seafood imitating product of Example 1 was obtained.

### [Evaluation]

The sensory test of the seafood imitating product produced by the method described above was performed. The evaluation was performed with the following procedures.

### 1. Carrying Out of the Sensory Test Procedure

The panelists carrying out the sensory test are people who have the experience of the inspection step of the product and can judge a flesh color of tuna, a rotting smell and an off odor. In addition, the panelists carrying out the sensory test who were passed a discrimination test of taste were picked.

As for the panelist, five panelists for bacteria testing operator, tuna workpiece and the seafood imitating product were picked. The sensory test was carried out under the following conditions.
The sensory test is performed at the time when the panelists are neither hungry nor full.
The test sample is inspected at the temperature when it is usually eaten.
The quantity of the test sample that the panelists can feel hardness to chew and feeling on the tongue is prepared.
The panelists who performed the sensory test judge colors, smells and tastes, and record a result.
The panelists who performed the sensory test judge including mouthfeel and syneresis, and record a result.
Before the test and while eating each product the influence on the test for next product is suppressed by, for example, drinking water.

The judgment of the propriety in the sensory test was carried out about four items of the following color, smell, mouthfeel and syneresis. The criterion of each item as follows.
Color: compared to tuna, salmon and squid, to have the color that is similar or close to.
Smell: not to have a rotting smell or an off-odor.
Mouthfeel: to have the mouthfeel that is close to tuna, salmon and squid and taste peculiar to the imitation food.
Syneresis: obvious syneresis does not occur at the time of defrosting.

### 2. Sensory Test Result

By the procedure described above, the seafood imitating product was produced five times, and the test was carried out. About all of five times of the seafood imitating product, all of five panelists judged all of items of color, smell, mouthfeel and syneresis to be qualified.

Also, the seafood imitating product produced by the method described above had a squid sashimi-like mouthfeel. Also, the seafood imitating product produced by the method described above had the squid-like appearance by coloring of white due to tapioca starch.

### Example 2

The tuna imitating product was produced.

### [Preparation of the Flesh Solution]

At first, the raw materials of ingredients showing in Table 1 was prepared to produce the tuna imitating product. In Table 3, the composition amount is shown in kg, and the composition ratio in the final flesh solution is shown as % by weight.

TABLE 3

| | composition amount | composition ratio |
|---|---|---|
| | (kg) | (% by weight) |
| raw materials 1 | | |
| clean water | 66 | 76.48% |
| lycopene(soy) | 0.15 | 0.17% |
| dextrin | 4 | 4.63% |
| mannan | 0.711 | 0.82% |
| carrageenan | 0.594 | 0.69% |
| locust bean gum | 0.24 | 0.28% |
| guar gum | 0.156 | 0.18% |
| gellan gum | 0.036 | 0.04% |
| xanthan gum | 0.012 | 0.01% |
| potassium chloride | 0.201 | 0.23% |
| glucose | 0.987 | 1.14% |
| agar | 0.063 | 0.07% |
| salt | 0.15 | 0.17% |
| raw materials 2 | | |
| clean water | 4 | 4.63% |
| cornstarch | 2.4 | 2.78% |
| tapioca starch | 1.6 | 1.85% |
| raw materials 3 | | |
| vegetable soup | 5 | 5.79% |
| total | 86.3 | 100.00% |

Ingredients shown in raw materials 1 were added into the pot of, outside size: 1,850 mm in width, 1,090 mm in depth, 1,160 mm in height, inside diameter of inner pot: 1,000 mm, depth of inner pot: 560 mm, quantity of full water: approximately 380 liters and mixed with a stirrer. The temperature was controlled at 30° C. or less.

On the other hand, the solution of cornstarch and tapioca starch shown in raw materials 2 was prepared. 2.4 kg of cornstarch (2.78% by weight in the final flesh solution) and 1.6 kg of tapioca starch (1.85% by weight in the final flesh solution) were put into 4 kg of water (4.63% by weight in the final flesh solution) and mixed. The mixing was performed at 30° C. or less. The prepared raw materials 2, the solution of cornstarch and tapioca, was put into the mixture of raw materials 1 described above.

The vegetable soup of raw materials 3 has composition showing in Table 2 described above.

Next, heating of contents of the pot was started. During heating, 5 kg of vegetable soup (5.79% by weight of the final flesh solution) was put into the pot containing raw materials 1 and raw materials 2.

Heating was stopped at the point when the contents of the pot exceeded 85° C. Thereby, the flesh solution was obtained.

The viscosity of the flesh solution of this time was measured. The viscosity was measured according to the procedure using VISCOMETER VT-06, RION CO., LTD. The viscosity was 70 dPa·s-80 dPa·s when the temperature of the flesh solution was at 80° C.-85° C.

Also, Brix level of the flesh solution was measured at the point when the temperature of the center core was at 85° C. by a Brix scale as the viscosity of the solution. The density of the flesh solution was 15%-18%. Note that, herein, “Brix level” is the physical quantity used as a sugar content to measure content of the sugar. When measuring 100 g of water solution including only 1 g of sucrose as a solute by Brix refractometer, the Brix level which is its indication is 1%. For example, as for the solution which 10 g of sucrose dissolved in 100 g of solution (90 g of water), a Brix level becomes 10%. For example, the flesh solution can be 1%-40%, 12%-20% or 15%-18% of Brix levels.

### [Preparation of the Tendon Solution]

The following raw materials were prepared.

TABLE 4

| | composition amount | composition ratio |
|---|---|---|
| raw materials | (kg) | (% by weight) |
| clean water | 7.7 | 93.09% |
| titanium dioxide | 0.44 | 5.32% |
| agar | 0.132 | 1.60% |
| total | 8.272 | 100.00% |

These raw materials were mixed to prepare the tendon solution. The tendon solution can be prepared by mixing titanium dioxide and/or calcium carbonate and the second thickener. For example, it can be prepared by mixing them in water. As used herein, the solution obtained by mixing at least titanium dioxide and/or calcium carbonate and the second thickener in water is referred to as tendon solution. The tendon solution is the material that forms the part imitating fish tendon. The word “fish tendon” also referred to fish muscle.

The viscosity of the tendon solution of this time was measured. The viscosity was measured according to the procedure using VISCOMETER VT-06, RION CO., LTD. When the temperature of the tendon solution was at 80° C.-85° C., the viscosity was 0.3 dPa·s-0.6 dPa·s, and it was the solution close to water which had low viscosity.

### [Formation of the Layer of the Flesh Solution and Formation of the Layer of the Tendon Solution]

The flesh solution at 80° C.-85° C. was put in a mold, and the layer of the flesh solution was formed. Then, on the layer of the flesh solution, the tendon solution at 80° C.-85° C. was poured, and the layer of the tendon solution was formed. To the thickness of the layer of flesh solution 1, the thickness of the layer of tendon solution 2 was set as 30 mm.

### [Formation of a Cut]

Next, cutting with a blade of a stainless plate of 5 mm from the above of the layer of the tendon solution, and a cut was made in the layer of the flesh solution by the blade through the layer of the tendon solution. After that, the blade was pulled up. Thereby, the tendon solution got into the cut of the layer of the flesh solution.

### [Solidification]

In this state, the flesh solution and the tendon solution were solidified, respectively. The flesh solution and the tendon solution were solidified by cooling the container at 0° C.-4° C. with a blast chiller, and a solidified body was obtained.

### [Freezing]

The solidified body was rapidly cooled in a freezer at −40° C., and the solidified body of the flesh solution and the tendon solution was frozen. The layer of the tendon solution which did not get into the layer of the flesh solution was shaved off from the frozen solidified body.

### [Defrosting]

The frozen solidified body was bagged, and the bag was sealed. The bag was put in warm water at 50° C. or less, and was left for 0.5 hours. Thereby, defrosting was performed to obtain the seafood imitating product of Example 2.

### [Evaluation]

As Example 1, the seafood imitating product of Example 2 was evaluated.

### <Sensory Test Result>

By the procedure described above, the seafood imitating product was produced ten times, and the test was carried out. About all of ten times of the seafood imitating product, all of five panelists judged all of items of color, smell, mouthfeel and syneresis to be qualified.

Also, the seafood imitating product produced by the method described above did not come off in the tendon parts because the tendon parts and the parts of the flesh were united. Also, the seafood imitating product produced by the method described above had a sashimi-like mouthfeel. Also, the seafood imitating product produced by the method described above had a red flesh-like appearance of tuna by coloring with white due to tapioca starch and red due to lycopene.

### Example 3

The salmon imitating product was produced.

### [Preparation of the Flesh Solution]

At first, to produce the salmon imitating product, the raw materials of ingredients showing in Table 2 were prepared. In the table, the composition amount is shown in kg, and the composition ratio in the final flesh solution is shown as % by weight.

TABLE 5

| | composition amount | composition ratio |
|---|---|---|
| | (kg) | (% by weight) |
| raw materials 1 | | |
| clean water | 66 | 76.41% |
| lycopene(soy) | 0.032 | 0.04% |
| paprika pigment | 0.16 | 0.19% |
| titanium dioxide | 0.032 | 0.04% |
| dextrin | 4 | 4.63% |
| mannan | 0.711 | 0.82% |
| carrageenan | 0.594 | 0.69% |
| locust bean gum | 0.24 | 0.28% |
| guar gum | 0.156 | 0.18% |
| gellan gum | 0.036 | 0.04% |
| xanthan gum | 0.012 | 0.01% |
| potassium chloride | 0.201 | 0.23% |
| glucose | 0.987 | 1.14% |
| agar | 0.063 | 0.07% |
| salt | 0.15 | 0.17% |
| raw materials 2 | | |
| clean water | 4 | 4.63% |
| cornstarch | 2.4 | 2.78% |
| tapioca starch | 1.6 | 1.85% |
| raw materials 3 | | |
| vegetable soup | 5 | 5.79% |
| total | 86.374 | 100.00% |

Ingredients shown in raw materials 1 were added in the pot of outside size: 1,850 mm in width, 1,090 mm in depth, 1,160 mm in height, inside diameter of inner pot: 1,000 mm, depth of inner pot: 560 mm, quantity of full water: approximately 380 liters similar to the one used in Example 1 and mixed with a stirrer. The temperature was controlled at 30° C. or less.

On the other hand, the solution of cornstarch and tapioca starch shown in raw materials 2 was prepared. 2.4 kg of cornstarch (2.78% by weight in the final flesh solution) and 1.6 kg of tapioca starch (1.85% by weight in the final flesh solution) were put into 4 kg of water (4.63% by weight in the final flesh solution), and mixed. The mixing was performed at 30° C. or less. The prepared raw materials 2, the solution of cornstarch and tapioca, was put into the mixture of raw materials 1 described above.

The vegetable soup of raw materials 3 has composition showing in Table 2 described above.

Next, heating of the contents of the pot was started as Example 1. During heating, 5 kg of vegetable soup (5.79% by weight of the final flesh solution) was put into the pot containing raw materials 1 and raw materials 2.

Heating was stopped at the point when the contents of the pot exceeded 85° C. Thereby, the flesh solution was obtained.

The viscosity of the flesh solution of this time was measured. The viscosity was measured according to the procedure using VISCOMETER VT-06, RION CO., LTD. The viscosity was 70 dPa·s-80 dPa·s when the temperature of the flesh solution was at 80° C.-85° C.

Also, the Brix level of the flesh solution was measured at the time when the temperature of the center core was at 85° C. by a Brix scale as the viscosity of the solution. The density of the flesh solution was 15%-18%.

### [Preparation of the Tendon Solution]

The tendon solution was prepared with the procedure same as Example 2.

### [Formation of the Layer of the Flesh Solution and Formation of the Layer of the Tendon Solution]

A layer of the flesh solution and a layer of the tendon solution were formed with the procedure same as Example 2.

### [Formation of a Cut]

A cut was formed with the procedure same as Example 2, and the tendon solution got into the cut of the layer of the flesh solution.

### [Solidification]

A solidified body was obtained with the procedure same as Example 2.

### [Freezing]

A solidified body was frozen, and the layer of the tendon solution which did not get into the layer of the flesh solution was shaved off from the frozen solidified body with the procedure same as Example 2.

### [Evaluation]

As Example 1, the seafood imitating product of Example 3 was evaluated.

### Sensory Test Result

By the procedure described above, the seafood imitating product was produced ten times, and the test was carried out. About all of ten times of the seafood imitating product, all of five panelists judged all of items of color, smell, mouthfeel and syneresis to be qualified.

Also, the seafood imitating product produced by the method described above did not come off in the tendon parts because the tendon parts and the parts of the flesh were united. Also, the seafood imitating product produced by the method described above had a sashimi-like mouthfeel. Also, the seafood imitating product produced by the method described above had a red flesh-like appearance of salmon by coloring with white due to tapioca starch and red due to paprika pigment and lycopene.

### INDUSTRIAL APPLICABILITY

The method for producing the seafood imitating product concerning the first embodiment of the present invention described above can reproduce the cloudiness of the flesh peculiar to the seafood which cannot be developed when not adding tapioca powder by solidifying the flesh solution obtained by heat mixing dietary fiber and tapioca powder, and freezing this solidified body. Also, the mouthfeel peculiar to the seafood can also be reproduced.

Also, color, cloudiness and mouthfeel of the red flesh of tuna and salmon can be reproduced by solidifying and freezing the flesh solution containing tapioca powder, paprika pigment and lycopene pigment, and the like.

Also, the method for producing the seafood imitating product concerning the second embodiment of the present invention described above can produce the seafood imitating product which the red color peculiar to tuna is reproduced by heat mixing dietary fiber and lycopene pigment in water, obtaining the flesh solution, solidifying this flesh solution and obtaining a solidified body.

### REFERENCE SIGNS LIST

1 . . . solidified body,
2 . . . seafood imitating product,
3 . . . layer of the flesh solution

All patents and non-patent-literature disclosed herein is incorporated by reference herein.

1. A method for producing a seafood imitating product including dietary fiber, comprising:
mixing dietary fiber, tapioca powder, thickener and water to obtain a flesh solution;
solidifying the flesh solution to obtain a solidified body; and
freezing the solidified body.

2. The method for producing the seafood imitating product according to claim 1, wherein the flesh solution is prepared by further mixing with a colorant different from the tapioca powder.

3. The method for producing the seafood imitating product according to claim 2, wherein:
the colorant is lycopene pigment; and
the method further comprises heating the flesh solution before solidifying the flesh solution.

4. The method for producing the seafood imitating product according to claim 1, wherein the freezing of the solidified body is performed at 0° C. or less.

5. The method for producing the seafood imitating product according to claim 2, wherein the freezing of the solidified body is performed at 0° C. or less.

6. The method for producing the seafood imitating product according to claim 3, wherein the freezing of the solidified body is performed at 0° C. or less.

7. The method for producing the seafood imitating product according to claim 1, wherein the flesh solution is prepared by further mixing with vegetable soup.

8. The method for producing the seafood imitating product according to claim 2, wherein the flesh solution is prepared by further mixing with vegetable soup.

9. The method for producing the seafood imitating product according to claim 3 wherein the flesh solution is prepared by further mixing with vegetable soup.

10. A method for producing a seafood imitating product including dietary fiber comprising:
mixing dietary fiber and lycopene pigment in water to obtain a flesh solution; heating the flesh solution; and
solidifying the flesh solution to obtain a solidified body.
